(19) United States
(12) Patent Application Publication
(10) Pub. No.: US 2012/0026506 A1
(43) Pub. Date: Feb. 2, 2012

(54) SYSTEM FOR IN VITRO ANALYSIS OF FLUID DYNAMICS ON CONTACT LENSES VIA PHASE SHIFTING INTERFEROMETRY

(76) Inventors: Brian C. Primeau, Tucson, AZ (US); John E. Greivenkamp, JR., Tucson, AZ (US); James William Haywood, Fleming Island, FL (US)

(21) Appl. No.: 13/195,612

(22) Filed: Aug. 1, 2011

Related U.S. Application Data
(60) Provisional application No. 61/400,798, filed on Aug. 2, 2010.

(51) Int. Cl. G01B 9/02; G01B 11/02

(52) U.S. Cl. 356/495; 356/511

(57) ABSTRACT

A system and method for analyzing the dynamics of fluid layers on contact lenses utilizes phase shifting interferometry to quickly and accurately model the time-evolution of the fluid layers. The system and method are utilized for in vitro studies.

### CROSS-REFERENCE TO RELATED APPLICATIONS

This patent application claims the benefit of U.S. Provisional Application No. 61/400,798 filed Aug. 2, 2010.

### BACKGROUND OF THE INVENTION

1. Field of the Invention

The present invention is directed to optical metrology, and more particularly to a system for measuring the dynamics and material interaction of fluid layers on contact lenses in vitro using phase shifting interferometry.

2. Discussion of the Related Art

In the human eye, the tear film is distributed over the cornea to create a smooth surface. Since the largest refractive index difference in the eye occurs at the air-to-tear film interface, this surface contributes a majority of the eye's optical power. In addition to its optical properties, the tear film serves to lubricate the eye, and in general keep it in a healthy state.

When a person blinks, a new tear film is distributed on the cornea. After the blink, the tear film stabilizes. At this point in time, the tear film is a smooth as it will ever be. Essentially, this is the optimal state for the tear film. If no blinking occurs, the tear film normally begins to breakup over a time period ranging from about four (4) to about fifteen (15) seconds. During the breakup, the tear film becomes turbulent and begins to dry up in places. This may cause decreased visual acuity along with discomfort. Non-uniformity in the tear film may also lead to refraction errors caused by light scatter.

When a contact lens is placed on the eye, layers of tear film form both between the contact lens and the cornea and over the anterior contact lens surface. Proper distribution of the tear film is critical to a achieving a comfortable lens fit and vision improvement, so lens materials must be designed to have a proper wettability. While some lens materials provide improvements such as increased oxygen permeability, their effects on tear film distribution are unknown. Presently, the lens must be tested in vivo during clinical trials where qualitative and only semi-quantitative tear film analysis methods, such as using fluorescein eye stain and slit lamp imaging, are used to evaluate tear film evolution and breakup. Therefore, a qualitative method of evaluating contact lens hydrophobicity in vitro is desired.

In current practice, one method of tear film examination relies on instilling fluorescein in an eye and examining the fluorescing light with a slit lamp or similar instrument. In this method, the examination is completely subjective and no quantitative analysis of the tear film can be made. Furthermore, introducing a foreign element into the eye could alter the tear film itself.

Another current method involves using a corneal topographer where a ring or grid pattern is reflected off of the tear film and their deviations from the desired shape provide information about the tear film topography. These systems have low sensitivity and spatial resolution and are not capable of measuring relatively small artifacts in the tear film.

A common in vitro characterization method relies on applying a drop of fluid to a contact lens wherein the fluid forms a bead on the surface thereof. A number of methods exist to measure the angle the bead forms between itself and the underlying substrate e.g. contact lens. This angle is the contact angle and is a common measure of the interaction between a liquid and solid sample. When water is applied to a substrate the contact angle describes the material's wettability; an obtuse angle corresponds to a more hydrophobic material, i.e. a water repellant material, while an acute angle corresponds to a more hydrophilic material, i.e. a water attraction material. If the substrate is strongly hydrophilic, the water drop will spread out evenly over the surface forming a contact angle near zero (0) degrees, while on a hydrophobic material or substrate, the water will form a more spherical bead and the contact angle will be larger than ninety (90) degrees.

While the contact angle measurement measures material properties at a local region, it does not necessarily predict behavior over the entire surface area. In the case of contact lenses infused or doped with materials to increase oxygen permeability, for example, there could be spatial variations across the lens surface that a contact angle measurement will not capture. In addition, the contact angle measurement does not provide a method of comparing how the fluid layer is behaving over the contact lens compared to a normal tear film.

Accordingly, there exists a need for developing an in vitro system and methodology for measuring the surface topography dynamics of fluid layers on contact lenses.

### SUMMARY OF THE INVENTION

The present invention overcomes many of the disadvantages associated with the current methods and systems for the evaluation of the dynamics of fluid layers on contact lenses.

In accordance with one aspect, the present invention is directed to a method for assessing the behavior of fluid on a surface comprising utilizing optical phase shifting interferometry of a low reflectance surface of the fluid to generate at last one data set and determine the dynamic characteristics of the low reflectance surface of the fluid therefrom.

In accordance with another aspect, the present invention is directed to a method for quantitatively assessing the behavior of fluid on a surface. The method comprising utilizing optical phase shifting interferometry on the surface to generate at least one data set, and analyzing the at least one data set to determine the dynamic characteristics of the fluid over a given period of time.

In accordance with another aspect, the present invention is directed to a system for assessing the behavior of fluid on a surface. The system comprising a polarization based interferometer arranged in a Twyman-Green configuration having both a test arm and a reference arm, and at least one simultaneous phase shifting device for capturing images produced by the polarization based interferometer.

Interferometry is a technique which utilizes the behavior of electromagnetic waves in a manner so as to extract information about the path length traveled by the waves. Essentially, in interferometry, electromagnetic waves are superimposed in a manner that will result in an interference pattern that has encoded useful information on the relative length of travel for the interfering waves.

The underlying principle behind interferometry is that when two waves having the same frequency combine, the resulting pattern is determined by the phase difference between the two waves. In other words, waves that are in phase will undergo constructive interference while waves that are out of phase will undergo destructive interference.

An interferometer may be utilized in an in vitro method of evaluating fluid interactions on contact lenses. The present invention utilizes phase shifting interferometry for analyzing the fluid dynamics on contact lenses. The phase shifting interferometer or interferometer provides an in vitro method of evaluating fluid interactions on contact lenses. Specifically, the interferometer measures the dynamic surface topography of the fluid layer on a contact lens.

The fluid simulates the behavior of the tear film that would occur on the human eye and the interferometer provides a means of quantitatively characterizing that interaction.

Phase shifting interferometry relies on using data from multiple interferograms to directly measure the phase of a wavefront under test. In one implementation, these interferograms are taken over time. For this specific application the fluid layer can change between each phase-shifted interferogram, so rapid data collection is required. A second and preferred embodiment makes use of an instantaneous phase shifting system, where multiple interferograms are recorded concurrently so that there are no changes in the fluid layer during the data acquisition portion of a measurement. A series of measurements can then record the time-evolution of the fluid layer.

### BRIEF DESCRIPTION OF THE DRAWINGS

The foregoing and other features and advantages of the invention will be apparent from the following, more particular description of preferred embodiments of the invention, as illustrated in the accompanying drawings.

FIG. 1 is a series of images depicting measurements of an actual fluid layer on a contact lens taken in accordance with the present invention.

FIG. 2 is a diagrammatic representation of the phase shifting interferometry system in accordance with the present invention.

FIG. 3 is a diagramatic representation of light passing through a converger in accordance with the present invention.

FIG. 4 is a series of images developed via blob analysis in accordance with the present invention.

### DETAILED DESCRIPTION OF THE PREFERRED EMBODIMENTS

The in vitro system of the present invention uses phase shifting interferometry to measure the dynamics of fluid layers on contact lenses. The in vitro system measures the phase of a wavefront reflected from the fluid layer and uses this information to calculate its topographic surface profile. Such a system provides superior sensitivity and accuracy as well as better spatial resolution compared with static interferometers and can measure dynamic surfaces. Static interferometry relies on tracing the fringe centers of a single interferogram and has lower spatial sampling and lateral resolution than the phase shifting method. Additionally, static interferometry requires additional information to determine the proper wavefront orientation. In the present invention, in addition to superior accuracy, sensitivity and spatial resolution, higher speed is also achieved. Prior shearing methodologies were fast, but lacked sensitivity and spatial resolution to detect artifacts in the tear film.

Phase shifting interferometry relies on using data from multiple interferograms to directly measure the phase of a wavefront under test. In one implementation, these interferograms are taken over time. For this specific application the fluid layer can change between each phase-shifted interferogram, so rapid data collection is required. A second and preferred embodiment makes use of an instantaneous phase shifting system, where multiple interferograms are recorded concurrently so that there are no changes in the fluid layer during the measurement. A series of measurements may then record the time-evolution of the fluid layer.

The process to capture the data is set forth below and is followed by a description of the system for implementing the process. The end result of data capture is a number of interferometric measurements of the fluid layer over time. Typically, around two hundred (200) measurements are taken at a rate of three (3) measurements per second. The system is capable of capturing measurements at a rate of twenty-five (25) frames per second, and the quantity is limited simply by the available data storage.

The first step in the process is turning on both the laser and the camera so that they are warmed up and stabilized. The next step in the process comprises setting up software to view live images from the camera. The next step in the process comprises wetting the lens holder with saline solution. Once the lens holder is wet, the contact lens is placed on the lens holder and re-wet with saline solution. The lens holder and the lens are then positioned at the proper location behind the converger, as discussed below, and aligned by adjusting its position laterally and axially until the fewest number of fringes appear in the live output video from the camera. Once this is complete, the next step comprises recording the interferometric data. The final step comprises simply stopping the recordation of interferograms once the desired duration has elapsed. Over the course of the process, the lens may be hydrated by applying a suitable solution thereto. Any type of solution may be utilized. For example, artificial tears may be utilized as well as a saline solution or simply de-ionized water. In addition, the lens may be hydrated with any suitable technique such as via a syringe or alternately, the lens may be dipped in the solution.

Once the data is captured, algorithms are utilized to convert the phase shifted interferograms into first phase information and that phase information is then converted into a single surface measurement. This process is repeated for each measurement. The measurements are then compared to determine how the fluid layer has changed over time. There are a number of ways of analyzing the resulting data set of surface measurements and it is expected that other ways will suggest themselves to those skilled in the relevant art without departing from the spirit and scope of the invention.

A first method is to just examine the unaltered or unedited measurements without any modification thereto. The unaltered or unedited measurements refer to the surface contour with only piston and tilt subtracted from the information. Statistics describing the surface may be captured for each measurement frame and output to a database as needed.

A second method relies on subtracting one “reference” frame from every measurement and analyzing that output. By referencing every measurement to one within the set, the changes in the fluid layer shape are easily seen and analyzed. In other words, any systematic or constant characteristics are filtered out. In one exemplary embodiment, the first collected surface is utilized as the reference surface. In an alternate exemplary embodiment, the surface corresponding to the time after blink, yielding the most stable vision (approximately one to two seconds after blink) is utilized as the reference surface. In yet another alternate exemplary embodiment, the most stable surface in the set, as determined by a particular metric, for example RMS, is used as the reference surface.

A third method relies on subtracting a fitted polynomial surface from each measurement. This differs from the second method described above in that the reference surface being subtracted now changes for each measurement. By doing this, only the high order surface perturbations are seen. It is thought that fluid layer break-up happens in a way that may not be described by simple polynomials, so subtracting such a surface makes those features easily identifiable.

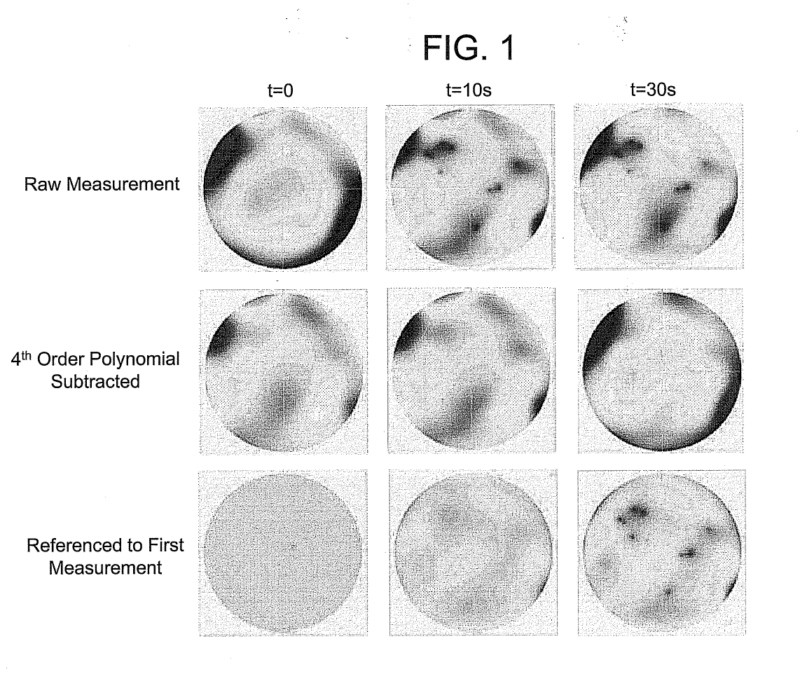

In all the above described methods, software scripts or algorithms are used to modify, analyze and save the desired data. Statistics may be saved to a database, and the visual surface representations may be combined to create a movie of the fluid layer evolution over time. FIG. 1 shows three measurements of an actual fluid layer on a contact lens. The measurements were taken at one (1), ten (10) and thirty (30) seconds after the lens was hydrated via the application of an artificial tear solution. Results of each of the previously described analysis methods are shown as well.

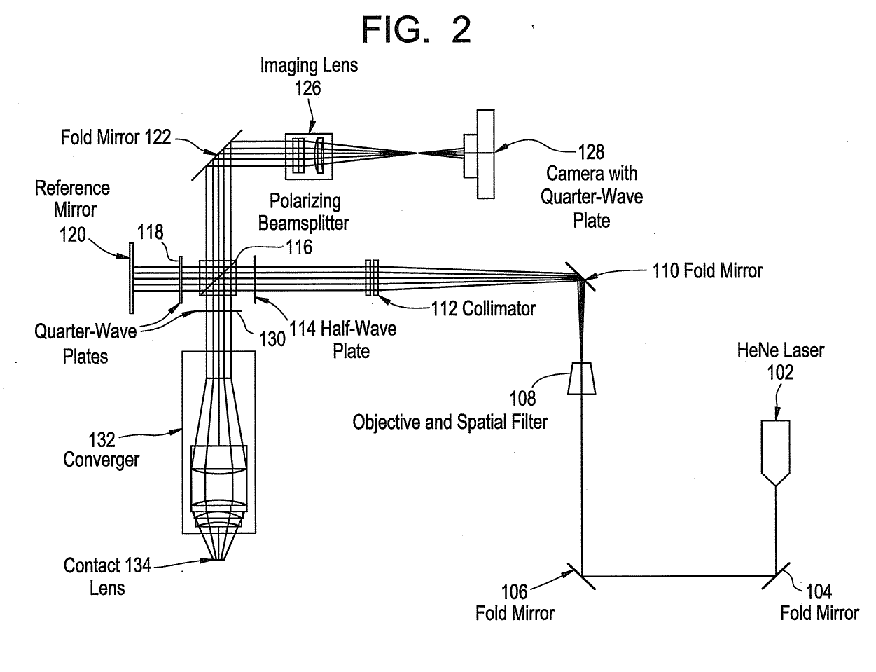

In a preferred exemplary embodiment, the interferometer is a custom built polarization based Twyman-Green system where the contact lens is positioned in a test arm of the system. The preferred exemplary embodiment is illustrated in block diagram format in FIG. 2. In an alternate exemplary embodiment, the interferometer may be built on a laser Fizeau configuration; however, as stated above, the Twyman-Green system is preferred because of its ability to more easily phase shift using the single shot method. In addition, the polarizing variant more easily allows adjustment of laser power into each arm of the interferometer, allowing testing over a larger range of reflectances. A converger is used to expand the beam and focus it at the center of curvature of the contact lens. In this method, the test beam is reflected back through the system where it is combined with a reference beam and directed to a camera. The resulting interference pattern between the two signals is used to calculate the phase of the wavefront reflected off of the fluid layer, and this information may be used to calculate a topographic map of that surface.

The light source 102 for the system comprises a laser. In the exemplary embodiment, the laser 102 comprises a stabilized HeNe laser with a wavelength of 632.8 nm. In an alternate exemplary embodiment, a stabilized HeNe laser with a wavelength of 543.5 nm may be utilized. A pair of fold mirrors 104 and 106 direct the light beam to a spatial filter 108 and collimating lens 112 via a fold mirror 110 wherein the beam is spatially filtered and expanded into an 18 mm diameter collimated beam. The collimated beam is then passed through a half wave plate 114 which allows the intensity in both the test and reference arms to be balanced, and is split into each arm with a polarizing beamsplitter cube 116. In the reference arm, the beam is passed through a quarter-wave plate 118 oriented with its fast axis at forty-five (45) degrees, is reflected off a reference mirror 120 and again passes back through the quarter-wave plate 118 and into the polarizing beamsplitter cube 116 where it is directed towards a camera 128, which is discussed in greater detail subsequently, via a fold mirror 122, imaging lens 124 and quarter-wave plate 126 oriented with its fast axis at forty-five (45) degrees. In the test arm, the beam pass through a quarter-wave plate 130 oriented with its fast axis at forty-five (45) degrees, a converger 132, which is described in greater detail subsequently, and is reflected off the fluid layer on a contact lens secured in a contact lens holder 134, which is also described in greater detail subsequently. The beam then passes back through the converger 132, the quarter-wave plate 130 and the polarizing beamsplitter cube 116 towards the camera 128 via the fold mirror 122, the imaging lens 124 and the quarter-wave plate 126. It is important to note that both the references and test beam pass through the imaging lens 124 which images the fluid layer onto the camera 128.

In order to analyze the dynamics of a fluid layer on a contact lens, care must be taken to properly hold and position the contact lens. Since lenses are inherently floppy, a rigid pedestal is preferably used to hold them. The geometry of this pedestal should match the base curvature of the contact lens under test. Mechanical considerations also may preferably be taken to keep the contact lens from sliding around on the pedestal, ensuring that it is properly centered in the measurement area for the duration of testing.

The optical reflection from the anterior surface of the fluid layer is only about 2.3 percent, so reflections from other interfaces may cause problems. Therefore the pedestal must not have a high reflection and either a material that is diffuse or optically black should preferably be used to hold the contact lens in place.

The wetting properties of the holder are also of importance. Contact lenses themselves have a high water concentration. If the lens holder is made from hydrophobic materials, the contact lens may stick or fold up on the surface, and air bubbles may easily form between the holder and the contact lens. These materials also may drive the fluid out of the lens, causing dry spots that are easily identifiable in the measurements. Therefore, the material should preferably be somewhat hydrophilic or the surface may be treated with a hydrophilic coating.

The contact lens holder 134 illustrated in FIG. 2 comprises a pedestal manufactured from Zeonor plastic. The part is machined to match the posterior surface of a contact lens, and a lip is included around the diameter of the lens to hold the lens in place. Once this pedestal is machined to optical specifications, it is sandblasted with a ninety (90) micron grit size for ten (10) to fifteen (15) seconds. This process maintains the base curvature required and creates a diffuse surface to eliminate reflections from the lens-to-holder interface. In order to achieve the proper hydrophilicity, the surface is treated with a solution consisting of seventy-five (75) percent Exxene AF-091 and twenty-five (25) percent water and sold by Speedo under the name Speedo Anti-fog Goggle Solution. This treatment creates a hydrophilic surface that allows the contact lens to interact properly with the holder. The pedestal is attached to mechanical stages that allow for lateral and axial positioning as needed.

The main purpose of the converger is to focus the laser at the center of curvature of the contact lens, ensuring that the reflected signal follows the proper path back towards the camera. The specific design of the converger is driven by the desired diameter to be tested on the contact lens, along with the working distance between the contact lens and the converger and the base curvature of the contact lens under test. The image space f/# of the converger must be less than or equal to the base curvature divided by the test diameter, which is mathematically given by equation

f/#=Rₗₑₙₛ/Dₜₑₛₜ.

As the desired test area increases, the f/# must become smaller. Assuming a constant working distance, this means the lens diameter must become larger as well. In general, increasing the working distance or increasing the test area also increases the converger diameter. Therefore, the desired test geometry must be balanced with practical manufacturing considerations.

Additionally, the effective f/# of the entire imaging system, including both the converger and the imaging lens must be sufficient to match the resolution of the camera. The cutoff frequency of the detector is the largest fringe frequency it is capable of resolving (i.e., smallest fringe spacing). The cutoff frequency of the imaging system is the largest frequency it is capable of transmitting through to the detector. The limiting detector resolution is given by the equation

ε_{Detector}=1/(2*dₚᵢₓₑₗ),

where dₚᵢₓₑₗ is the pixel pitch on the detector. The imaging lens cutoff frequency is given by

εimaging=1/(λ*f/#_{w}),

where λ is the wavelength and f/#_{w} is the working, or effective, f/# of the imaging system. In order to achieve a detector limited system, which is preferable, the imaging lens cutoff frequency must be larger than the detector cutoff frequency.

In the exemplary embodiment, the converger 132 is designed to test a six (6) millimeter diameter area on the contact lens and provide a working distance of twenty-five (25) millimeters between the last element of the converger 132 and the contact lens, and assumes an eight (8) millimeter radius of curvature on the contact lens. Based on these requirements, the image space f/# of the system must be 1.33 or faster and more preferably, 1.4 or faster.

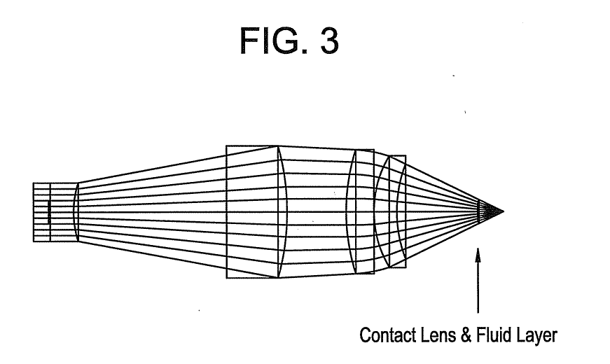

In this exemplary system, beam expanding optics are also incorporated into the converger system in order to produce enough beam to achieve the required f/# and working distance. The optics first expand an input beam having a diameter of 18 millimeters and then bring it to a focus at the proper location. FIG. 3 illustrates the optical layout of the converger system 132. For scale, the optical system length from first to last surface is 114.1 millimeters and the largest diameter is 41.15 millimeters.

The detector or camera 128 in the system is a Pixelated Camera Kit from 4D Technology Corporation. This camera comprises a CCD where a pixilated phase mask is aligned to the sensor. The purpose of the phase mask is to create four phase shifted interferograms on a single detector. In this way, instantaneous phase shifting interferometry may be used to measure the dynamic fluid layer interaction with a contact lens. Alternately, there are simultaneous phase shifting systems that utilize multiple cameras and polarizers. In addition, the simultaneous system may be replaced with high speed cameras and rapid phase shifting. In other words, any suitable means for capturing the images may be utilized in conjunction with any suitable means for phase shifting.

While the measured fluid layer surfaces may be described with traditional optical metrics such as RMS surface height or aberration terms, these metrics do not adequately describe the fluid layer topography. Features such as pits in the fluid layer are an early indication of fluid layer breakup, and their presence is not quantified with the aforementioned metrics. It is important to know precisely when and where these artifacts begin. The presence of these artifacts in the fluid layer indicates the layer is beginning to degrade, which on the eye can cause discomfort or vision degradation. Therefore, a “blob analysis” routine was developed to analyze the measurements in order to identify and quantify holes or pits in the fluid layer. Blob analysis is a simple form of texture analysis and generally involves various methods of extracting textural features from images. It is important to note that the analysis is preferably done over multiple and differently sized apertures because a stated RMS value for a given measurement aperture may be arrived at by surfaces that might be characterized as smooth or rough. Multiple measurements over different aperture sizes are thus needed to remove the ambiguity, to better determine the spatial frequencies of the surface within the test aperture.

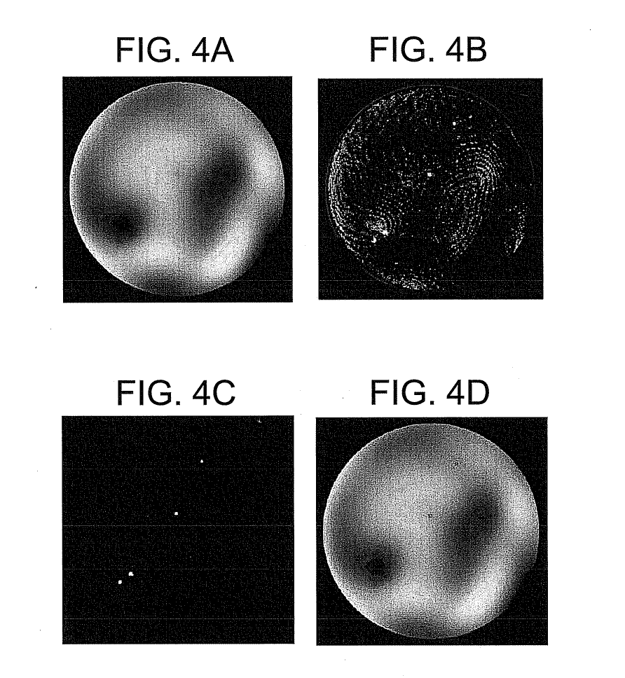

FIG. 4 shows the four major steps in the blob analysis routine developed in conjunction with this instrument. The first step of the blob analysis procedure is to import the surface measurement into IDL (ITT Visual Information Solutions, Boulder, Colo.). In step two an un-sharp mask is applied to the measurement which effectively amplifies the high frequency areas on the surface corresponding to the perimeter of the blobs. The original measurement is then subtracted from the unsharp masked version leaving data only at those areas enhanced by the unsharp mask, and a smoothing kernel applied to remove noise, leaving only areas of interest (the blobs) in the fluid layer visible. At this point (end of step 3) the processed measurement is a binary data array consisting of high values where the blob exists and low values everywhere else. In the final step perimeters are fit to every individual blob and the number of blobs along with their areas and locations are recorded.

Other methods of analysis include wavelet analysis, fractal analysis and Fourier Transform analysis.

While the system and methodology described herein focuses on contact lenses, there are a number of ophthalmic applications, including intraocular lenses, as well as excised human or animal cornea, and non-ophthalmic applications, including any type of lens or reflective surface, for the present invention.

Although shown and described is what is believed to be the most practical and preferred embodiments, it is apparent that departures from specific designs and methods described and shown will suggest themselves to those skilled in the art and may be used without departing from the spirit and scope of the invention. The present invention is not restricted to the particular constructions described and illustrated, but should be constructed to cohere with all modifications that may fall within the scope of the appended claims.

What is claimed is:

1. A method for assessing the behavior of fluid on a surface comprising utilizing optical phase shifting interferometry of a low reflectance surface of the fluid to generate at last one data set and determine the dynamic characteristics of the low reflectance surface of the fluid therefrom.

2. The method for assessing the behavior of fluid on a surface according to claim 1, wherein the surface is a lens.

3. The method for assessing the behavior of fluid on a surface according to claim 1, wherein the surface is a contact lens.

4. The method for assessing the behavior of fluid on a surface according to claim 1, wherein the surface is an intraocular lens.

5. The method for assessing the behavior of fluid on a surface according to claim 1, wherein the surface is an excised cornea.

6. The method for assessing the behavior of fluid on a surface according to claim 1, wherein the at least one data set is converted into first phase information which is subsequently converted into a first single surface measurement; repeating the conversion for each data set; and comparing the surface measurements to determine how the fluid has changed over time.

7. The method for assessing the behavior of fluid on a surface according to claim 6, wherein the step of analyzing comprises examining the surface measurements with only piston and tilt subtracted from the data utilized to create the surface measurements.

8. The method for assessing the behavior of fluid on a surface according to claim 6, wherein the step of analyzing comprises subtracting a predetermined reference from each of the surface measurements.

9. The method for assessing the behavior of fluid on a surface according to claim 6, wherein the step of analyzing comprises subtracting a fitted polynomial surface from each of the surface measurements.

10. A method for quantitatively assessing the behavior of fluid on a surface, the method comprising:
utilizing optical phase shifting interferometry on the surface to generate at least one data set; and
analyzing the at least one data set to determine the dynamic characteristics of the fluid over a given period of time.

11. The method for quantitatively assessing the behavior of fluid on a surface according to claim 10, wherein the surface has a low reflectance.

12. The method for quantitatively assessing the behavior of fluid on a surface according to claim 10, wherein the surface is a lens.

13. The method for quantitatively assessing the behavior of fluid on a surface according to claim 10, wherein the surface is a contact lens.

14. The method for quantitatively assessing the behavior of fluid on a surface according to claim 10, wherein the surface is an intraocular lens.

15. The method for quantitatively assessing the behavior of fluid on a surface according to claim 10, wherein the surface is an excised cornea.

16. The method for quantitatively assessing the behavior of fluid on a surface according to claim 10, wherein the at least one data set is converted into first phase information which is subsequently converted into a first single surface measurement; repeating the conversion for each data set; and comparing the surface measurements to determine how the fluid has changed over time.

17. The method for quantitatively assessing the behavior of fluid on a surface according to claim 16, wherein the step of analyzing comprises examining the surface measurements with only piston and tilt subtracted from the data utilized to create the surface measurements.

18. The method for quantitatively assessing the behavior of fluid on a surface according to claim 16, wherein the step of analyzing comprises subtracting a predetermined reference from each of the surface measurements.

19. The method for quantitatively assessing the behavior of fluid on a surface according to claim 16, wherein the step of analyzing comprises subtracting a fitted polynomial surface from each of the surface measurements.

20. The method for quantitatively assessing the behavior of fluid on a surface according to claim 10, further comprising texture analysis on the at least one data set.

21. The method for quantitatively assessing the behavior of fluid on a surface according to claim 20, wherein the texture analysis comprises blob analysis.

22. A system for assessing the behavior of fluid on a surface comprising:
a polarization based interferometer arranged in a Twyman-Green configuration having both a test arm and a reference arm; and
at least one simultaneous phase shifting device for capturing images produced by the polarization based interferometer.

23. The system for assessing the behavior of fluid on a surface according to claim 22, wherein the polarization based interferometer comprises a converger positioned in the test arm to focus light at a center of the surface.

24. The system for assessing the behavior of fluid on a surface according to claim 23, wherein the converger has an image space f/# less than or equal to 1.4

25. The system for assessing the behavior of fluid on a surface according to claim 22, further comprising a holder for holding the surface, the holder being configured to allow the surface to be repeatedly wetted.

26. The system for assessing the behavior of fluid on a surface according to claim 25, wherein the surface comprises a lens.

27. The system for assessing the behavior of fluid on a surface according to claim 25, wherein the surface is a contact lens.

28. The system for assessing the behavior of fluid on a surface according to claim 25, wherein the surface is an intraoccular lens.

29. The surface for assessing the behavior of fluid on a surface according to claim 25, wherein the surface has a low reflectance.
